(19) United States
(12) Patent Application Publication
(10) Pub. No.: US 2005/0226612 A1
(43) Pub. Date: Oct. 13, 2005

(54) Automatic diaphragm assembly with a variable aperture for a lens

(75) Inventor: Yao-Ching Haung, Taichung Hsien (TW)

Correspondence Address: NIKOLAI & MERSEREAU, P.A., 900 SECOND AVENUE SOUTH, SUITE 820, MINNEAPOLIS, MN, 55402, US

(73) Assignee: Asia Optical Co., Inc., T.E.P.E (TW)

(21) Appl. No.: 10/821,015

(22) Filed: Apr. 8, 2004

(51) Int. Cl. G03B 9/02

(52) U.S. Cl. 396/508

(57) ABSTRACT

An automatic diaphragm assembly for a lens of a digital camera includes a body, an actuating device and an aperture adjustment mechanism. The body has a diaphragm chamber with a bottom and a distal through hole defined completely through the bottom. The aperture adjustment mechanism is slidably mounted in the diaphragm chamber and includes two reciprocal blades. Each of the reciprocal blades has a V-shaped inward edge facing each other to define an aperture aligned with the distal through hole. The actuating device actuates the reciprocal blades to continuously change a size of the aperture by moving the reciprocal blades to close or open the aperture defined by the inward edges. Therefore, the diaphragm assembly allows continuous adjustment of the aperture without any stops to provide a proper aperture for a correct exposure.

### BACKGROUND OF THE INVENTION

1. Field of the Invention

The present invention relates to a diaphragm assembly for a lens, and more particularly to an automatic diaphragm assembly that is driven by a motor to define a variable aperture and is suitable for digital cameras.

2. Description of Related Art

Diaphragm assemblies in cameras limit the aperture for a lens, which allows an amount of light passing through the aperture to enter the cameras. Taking a great photograph requires precise control of the aperture to control the amount of light entering the cameras. Digital cameras have become popular for nonprofessional users because digital cameras are convenient to use. A digital camera today must be compact and tiny so it can be conveniently carried and slipped into a pocket. Therefore, a diaphragm assembly for a lens in a digital camera needs to be compact, also.

A conventional diaphragm assembly in accordance with the prior art is manually operated and uses a rotatable blade that has multiple preset openings with various diameters to define an aperture size for the lens. The openings have unique diameters and are arranged sequentially along a curved line. Each of the openings represents a stop, so-called f-stop, which appears on an aperture adjusting ring on a lens barrel of the camera. A person needs to rotate the aperture adjusting ring to select a desired opening for a correct exposure.

Since the quantity of preset openings is restricted, a range of stops to adjust the aperture defined by the diaphragm assembly for the lens is also limited. For high quality pictures, an opening of the aperture should be accurately controlled to allow a correct amount of light to pass through the aperture. The manually operated preset openings cannot be varied to any desired size of aperture. A person may not be able to acquire a proper aperture size to take a well-exposed photograph because only the f-stops appearing on the aperture-adjusting ring can be selected.

To overcome the shortcomings, the present invention provides an automatic diaphragm assembly that can continuously precisely adjust a proper size of an aperture for lens to mitigate or obviate the aforementioned problems.

### SUMMARY OF THE INVENTION

The main objective of the invention is to provide an automatic diaphragm assembly for a lens of a digital camera to precisely limit the amount of light entering the camera for a person to take high quality pictures.

Another objective of the invention is to provide a modular diaphragm assembly to improve efficiency of assembling cameras and lower manufacturing costs.

An automatic diaphragm assembly for a lens of a digital camera includes a body, an actuating device and an aperture adjustment mechanism. The body has a diaphragm chamber with a bottom and a distal through hole defined completely through the bottom. The aperture adjustment mechanism is movably mounted in the diaphragm chamber and includes two reciprocal blades. Each of the reciprocal blades has a V-shaped inward edge that faces the other blade to define an aperture aligned with the distal through hole. The actuating device actuates the reciprocal blades to continuously change the size of the aperture by reciprocally moving the reciprocal blades to close or open the aperture defined by the inward edges. Therefore, the diaphragm assembly is able to continuously adjust the aperture without any stops to provide a proper aperture for a correct exposure.

Other objectives, advantages and novel features of the invention will become more apparent from the following detailed description when taken in conjunction with the accompanying drawings.

### BRIEF DESCRIPTION OF THE DRAWINGS

FIG. 1 is an exploded perspective view of an automatic focus lens with a diaphragm assembly in accordance with the present invention;

FIG. 2 is an enlarged perspective view of a diaphragm assembly in FIG. 1;

FIG. 3 is an enlarged, exploded and perspective view of the diaphragm assembly in FIG. 2;

FIG. 4 is an enlarged, operational rear plan view of the diaphragm assembly in FIG. 2 wherein an aperture is defined by two reciprocal blades of the diaphragm assembly; and

FIG. 5 is an enlarged, operational rear plan view of the diaphragm assembly in FIG. 2 wherein the aperture is closed.

### DETAILED DESCRIPTION OF PREFERRED EMBODIMENT

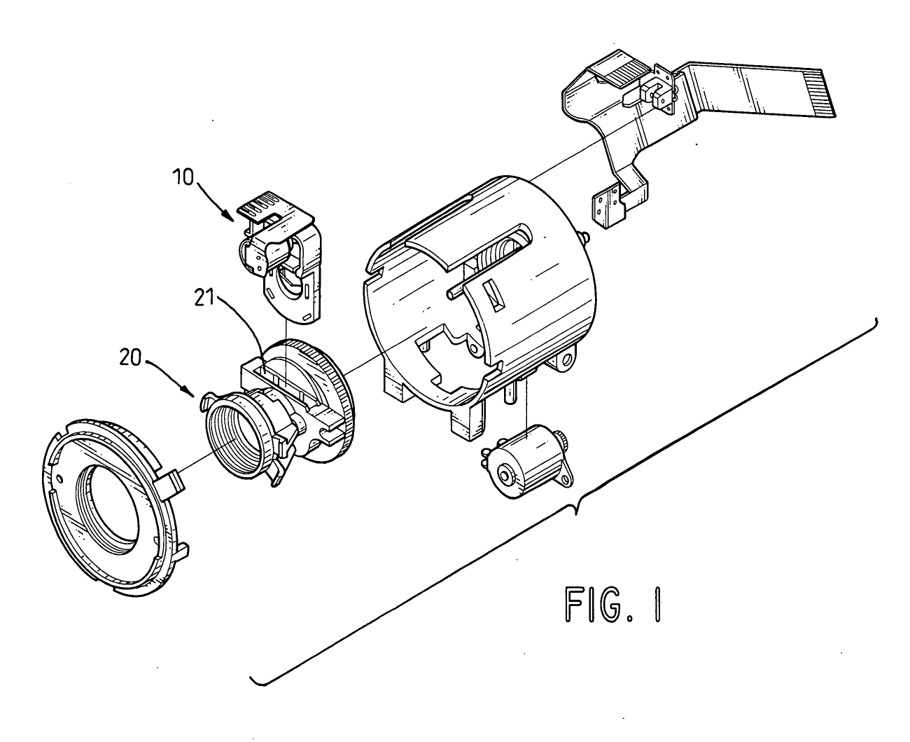

With reference to FIG. 1, an automatic diaphragm assembly (10) in accordance with the present invention is mounted in a lens mount (20) of a digital camera (not shown). The lens mount (20) has an optical passage (not numbered) to hold multiple lenses (not shown) and a diaphragm slot (21). The diaphragm slot (21) is longitudinally defined in the lens mount (20) to receive a portion of the diaphragm assembly (10).

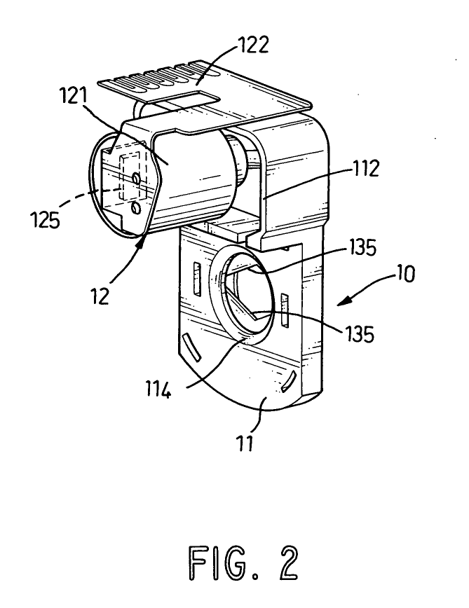

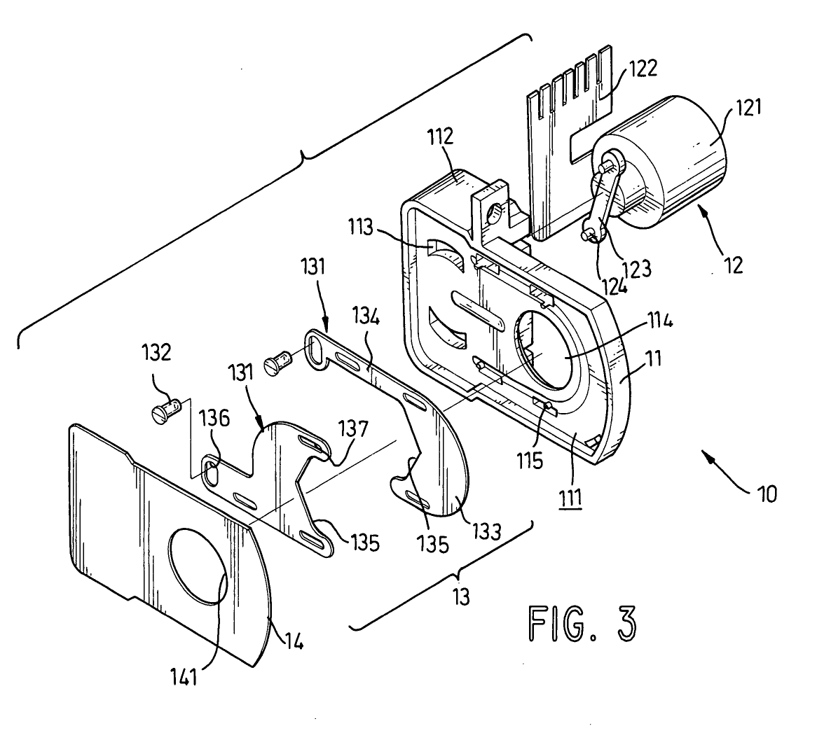

With further reference to FIGS. 2 and 3, the diaphragm assembly (10) comprises a body (11), a motor mount (112), an actuating device (12), an aperture adjustment mechanism (13) and an end cover (14). The body (11) has a front (not numbered), a rear (not numbered), a diaphragm chamber (111), two curved slots (113), a distal through hole (114) and four positioning nubs (115). The diaphragm chamber (111) is defined in the rear and has a bottom (not numbered). The motor mount (112) integrally protrudes from the front of the body (11). The curved slots (113) are defined completely through the bottom of the diaphragm chamber (111) of the body (11) and are aligned with the motor mount (112). The distal through hole (114) is defined completely through the bottom of the diaphragm chamber (111) of the body (11) at a position outside the motor mount (12), is aligned with the optical passage of the lens mount (20) as the body (11) is inserted and held in the diaphragm slot (21) and has a center (not shown). The positioning nubs (115) protrude from the bottom of the diaphragm chamber (111) and are arranged in a rectangular disposition.

The actuating device (12) is mounted on the motor mount (112) and comprises a motor (121), an interface (122), a transverse rod (123), two driving studs (124) and a current sensor (125). The motor (121), which may be a step motor, is mounted in the motor mount (112) and has a shaft (not shown) that extends toward the front of the body (11). The interface (122) connects electrically to the motor (121) and has an inner segment (not numbered) that extends into the motor (121). The interface (122) provides a connection for the motor (121) to a servo controller (not shown) so that the servo controller can control the motor (121) to either reverse or forward rotate the shaft of the motor (121). The transverse rod (123) is attached to and rotated by the motor shaft and has two opposite ends (not numbered). The driving studs (124) are respectively attached to the ends of the transverse rod (123), and each of the driving studs (124) has an outside end (not numbered). The outside ends of the driving studs (124) extend respectively into the curved slots (113) so that the driving studs (124) are respectively slidably held in the curved slots (113). The current sensor (125) is mounted on the inner segment of the interface (122) in the motor (121), electrically connects to the interface (122) and comprises a Hall element to sense a value of current of the stator of the motor (121). The sensed value of stator current is returned to the servo controller through the interface (122) to serve as a feedback control system for controlling revolutions of the motor (121).

The aperture adjustment mechanism (13) is slidably mounted in the diaphragm chamber (111) of the body (11) and comprises two reciprocal blades (131) and two end caps (132). Each of the reciprocal blades (131) has an overlapping segment (133), a driven arm (134) and multiple elongated transverse slots (137). The overlapping segments (133) are stacked one on top of the other and each of them has an inward edge (135). The inward edge (135) has a V-shaped profile with an open (not numbered) that faces the other to define an aperture (not numbered) aligned with the distal through hole (114) in the body (11). Therefore, a size of the aperture is variable by reciprocally moving the reciprocal blades (131). Pulling the reciprocal blades (131) close to each other makes the inward edges (135) close to each other to reduce the aperture size. Pushing the reciprocal blades (131) away from each other makes the inward edges (135) separate from each other to increase the aperture size. The elongated transverse slots (137) are defined in the overlapping segments (131) and respectively and slidably hold the positioning nubs (115).

The driven arms (134) of the reciprocal blades (131) extend toward the curved slots (113) from the overlapping segments (133) and have respectively a longitudinal through hole (136) aligned with one of the curved slots (113). The end caps (132) respectively insert into the longitudinal through holes (136), extend into the curved slots (113) and are respectively attached to the outside ends of the driving studs (124).

The end cover (14) covers the diaphragm chamber (111) and has a proximal through hole (141) aligned with the distal through hole (114) in the body (11).

With reference to FIG. 4, as the motor (121) rotates the transverse rod (123) in a forward direction, the driving studs (124) respectively move the connected reciprocal blades (131) along the curved slots (113) to separate the inward edges (135) from each other. The separating movements of the reciprocal blades (131) open the aperture to increase the size of the aperture.

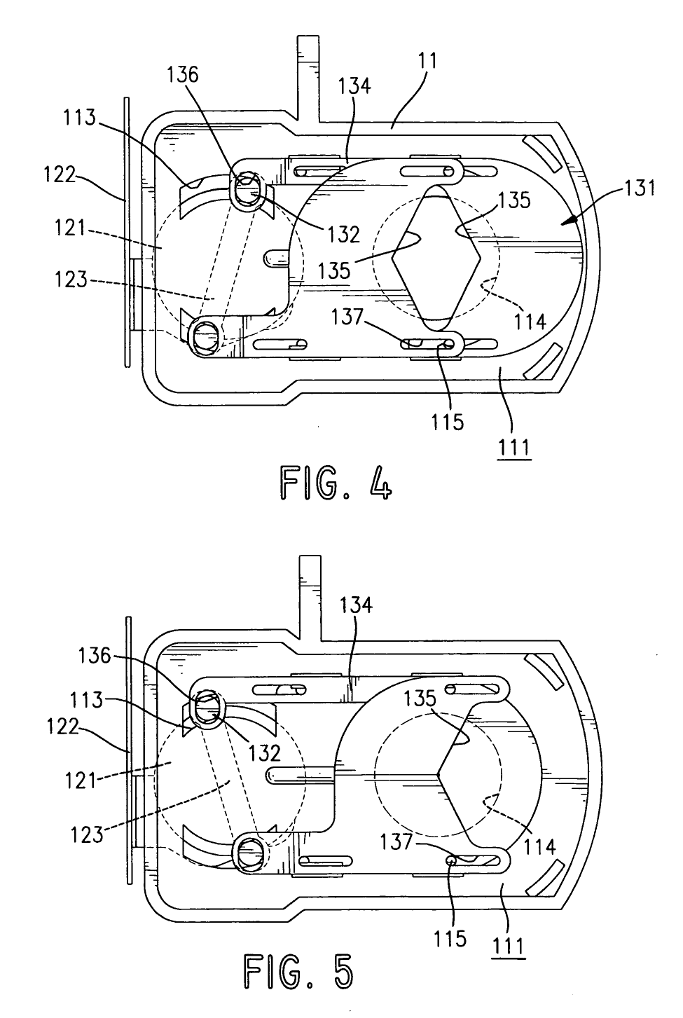

With reference to FIG. 5, as the motor (121) rotates the transverse rod (123) in a reverse direction, the driving studs (124) respectively move the connected reciprocal blades (131) along the curved slots (113) to move the inward edges (135) toward each other. The closing movements of the reciprocal blades (131) close the aperture to reduce the size of the aperture.

Since the angular positions of the transverse rod (123) are precisely controlled by controlling the revolutions of the motor shaft with the servo controller, continuously closing or separating the reciprocal blades (131) to accurately close or open the aperture is easy to achieve. Using the servo controller to precisely control the angular positions of the motor shaft has been well developed in this field and thus is not further discussed here. Consequently, an amount of light in the camera is accurately controlled and kept at an optimum state by changing the size of the aperture surrounded by the inward edge (135) to take the best picture possible.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the scope of the appended claims.

1. An automatic diaphragm assembly for a lens, and the diaphragm assembly comprising:
a body having a front, a rear, a diaphragm chamber with a bottom defined in the rear and a distal through hole defined completely through the bottom of the diaphragm chamber;
an aperture adjustment mechanism movably mounted in the diaphragm chamber and comprising two reciprocal blades slidably mounted in the diaphragm chamber, and each of the reciprocal blades having an inward edge facing to each other to define an aperture aligned with the distal through hole; and
an actuating device mounted on the body, connected to the reciprocal blades to continuously actuate the reciprocal blades moving to define the aperture.

2. The automatic diaphragm assembly as claimed in claim 1, wherein
the diaphragm assembly further comprises a motor mount formed integrally from the front of the body; and
the actuating device comprises
a motor mounted in the motor mount and having a shaft extended toward the front of the body and a stator;
an interface electrically connected to the motor and having an inner segment extended into the motor;
a transverse rod attached to and rotated by the motor shaft and having two opposite ends;
two driving studs are respectively attached to the ends of the transverse rod and extended into the diaphragm chamber to respectively connect to the reciprocate blades; and
a current sensor mounted on the inner segment of the interface in the motor to sense a current of the stator of the motor.

3. The automatic diaphragm assembly as claimed in claim 2, wherein
the body further has two curved slots defined completely through the bottom of the diaphragm chamber;
each of the driving studs has an outside end, and the outside ends are respectively extended into and slidably held in the curved slots;
each of the reciprocal blades has an overlapping segment and a driven arm extended from the overlapping segment, and each driven arm has a longitudinal through hole aligned with a respective one of the curved slots; and
the aperture adjustment mechanism further comprises an end cap slidably mounted in the longitudinal through hole of each one of driven arms and attached to the driving stub in the aligned curved slot.

4. The automatic diaphragm assembly as claimed in claim 3, wherein
the body further has four positioning nubs protruded from the bottom of the diaphragm chamber and the positioning nubs are arranged in a rectangular disposition; and
each of the reciprocal blades has multiple transverse slots and each of the transverse slots slidably holds a respective one of the positioning nubs.

5. The automatic diaphragm assembly as claimed in claim 3, wherein the inward edge of each of the reciprocal blades is defined in the overlapping segment and has a V-shaped profile with an opening facing each other.

6. The automatic diaphragm assembly as claimed in claim 4, wherein the inward edge of each of the reciprocal blades is defined in the overlapping segment and has a V-shaped profile with an opening facing each other.

7. The automatic diaphragm assembly as claimed in claim 2, wherein the motor is a step motor.

8. The automatic diaphragm assembly as claimed in claim 2, wherein the current sensor comprises a Hall element to sense currents in the stator.

9. The automatic diaphragm assembly as claimed in claim 2, further comprising an end cover attached to the rear of the body to cover the diaphragm chamber and having a proximal through hole aligned with the distal through hole in the body.

10. The automatic diaphragm assembly as claimed in claim 6, wherein the motor is a step motor.

11. The automatic diaphragm assembly as claimed in claim 10, wherein the current sensor comprises a Hall element to sense currents in the stator.

12. The automatic diaphragm assembly as claimed in claim 11, further comprising an end cover attached to the rear of the body to cover the diaphragm chamber and having a proximal through hole aligned with the distal through hole in the body.
